(19) United States
(12) Patent Application Publication
(10) Pub. No.: US 2010/0026582 A1
(43) Pub. Date: Feb. 4, 2010

(54) NEAR-FIELD RADIO FREQUENCY IDENTIFICATION READER ANTENNA

(75) Inventors: Won Kyu CHOI, Daejeon (KR); Jeongseok KIM, Daejeon (KR); Ji-Hoon BAE, Daejeon (KR); Gil Young CHOI, Daejeon (KR); Jong-Suk CHAE, Daejeon (KR)

Correspondence Address: CANTOR COLBURN, LLP, 20 Church Street, 22nd Floor, Hartford, CT, 06103, US

(73) Assignee: ELECTRONICS AND TELECOMMUNICATIONS RESEARCH INSTITUTE, Daejeon (KR)

(21) Appl. No.: 12/272,373

(22) Filed: Nov. 17, 2008

(30) Foreign Application Priority Data
Aug. 4, 2008 (KR) 10-2008-0076036

(51) Int. Cl. H01Q 1/38

(52) U.S. Cl. 343/700 MS

(57) ABSTRACT

A near-field radio frequency identification (RFID) reader antenna includes: a plurality of pairs of slots being formed on a ground surface of a single dielectric layer to emit a field; and a micro-strip line being formed on another surface of the single dielectric layer and having an open end to feed the plurality of pairs of slots.

### CROSS-REFERENCE TO RELATED APPLICATION

This application claims priority from Korean Patent Application No. 10-2008-0076036, filed on Aug. 4, 2008, in the Korean Intellectual Property Office, the entire disclosure of which is incorporated herein by reference.

### BACKGROUND OF THE INVENTION

1. Field of the Invention

The present invention relates to a near-field radio frequency identification (RFID) reader antenna that can form a plurality of pairs of slots on a ground surface of a single dielectric layer to emit a field and form a micro-strip line with an open end on another surface of the single dielectric field to feed the plurality of pairs of slots and thereby uniformly form the magnitude and phase of an electric field on the plurality of pairs of slots, and also can readily recognize a large number of tags approaching the near-field RFID reader antenna.

This work was supported by the IT R&D program of MIC/IITA. [2008-F-052-01, Near-Field RFID Reader Antenna for Item Level Tagging

2. Description of Related Art

Radio frequency identification (RFID) is a next generation recognition technology that can wirelessly communicate with an integrated circuit (IC) chip of a tag to thereby manage information regarding various types of objects such as products, animals, items, and the like. The application field of RFID has been expanded from a pallet, a case, or a box unit recognition to individual item recognition, that is, current item level tagging. Generally, for the item level tagging, RFID technology of a high frequency (HF) band has been preferred but has currently caused a number of problems including the size and price of the tag, recognition distance, a data processing speed, compatibility with an existing RFID standard of an ultra high frequency (UHF) band, and the like.

While the RFID technology of HF band adopts a magnetic coupling scheme, the RFID technology of UHF band adopts a backscattering scheme of electromagnetic waves. Due to the relatively long recognition distance, for example, about 3 m to about 5 m, the RFID technology of UHF band has been widely used for pallet-based distribution and box-based material management.

However, in the case of an application field of the item level tagging where a large number of products are gathered, a recognition rate may be significantly reduced due to scattering and interference of electromagnetic waves. Therefore, in order to overcome the disadvantages of the RFID technology of the UHF band that are found in the item level tagging, active research is being conducted on an RFID technology using a near field in the UFH band.

Unlike the RFID of the HF band using the magnetic coupling scheme, when using the near field of the UHF band, it is possible to appropriately select the magnetic coupling scheme and an electric coupling scheme according to a service environment and a product with an attached tag.

However, a near-field RFID reader antenna of the UHF band may need to be designed in a different concept from an existing far-field antenna. Specifically, the near-field RFID reader antenna may need to be designed based on an item level tagging environment, a tag attachment location, a required near-field distribution, and the like. Also, near-field communication is performed according to a coupling scheme between a reader antenna and a tag antenna and thus the structure of the tag antenna needs to be considered when designing the reader antenna.

For management of books placed on a bookcase or for management of products placed on a shelf using the near-field RFID, a fading zone needs to be removed by uniformly forming a field distribution on the bookcase or the shelf. However, when using a plurality of reader antennas, usage efficiency of ports of the reader antennas may be deteriorated and also antenna elements need to be switched at each time interval, which results in deteriorating a data processing speed. Accordingly, it may be very difficult to design the near-field reader antenna having the above-described characteristics.

Accordingly, there is a need for a near-field RFID reader antenna that can form a plurality of pairs of slots on a ground surface of a single dielectric layer to emit a field and can form a micro-strip line with one end on another surface of the single dielectric layer to feed the plurality of pairs of slots and thereby uniformly form the magnitude and phase of an electric field on the plurality of pairs of slots, and also can readily recognize a large number of tags approaching the near-field RFID reader antenna.

### SUMMARY OF THE INVENTION

An aspect of the present invention provides a near-field radio frequency identification (RFID) reader antenna that can form a plurality of pairs of slots on a ground surface of a single dielectric layer to emit a field and form a micro-strip line with an open end on another surface of the single dielectric layer to feed the plurality of pairs of slots and thereby can widely form a uniform near field.

Another aspect of the present invention also provides a near-field RFID reader antenna that can form a pair of slots in a position that is spaced apart from an end of a micro-strip line by λ/4, and where a current distribution is maximum based on a resonant frequency, and in a position that is spaced apart from the position of λ/4 by λ and where the current distribution is maximum and thereby can feed current distribution with a uniform magnitude and phase.

Still another aspect of the present invention also provides a near-field RFID reader antenna that can adjust a field coupling amount emit in two slots using any one of a slot width, a slot length, an interval between two slots constituting a pair, and an offset length between the slots.

According to an aspect of the present invention, there is provided a near-field RFID reader antenna including: a plurality of pairs of slots being formed on a ground surface of a single dielectric layer to emit a field; and a micro-strip line being formed on another surface of the single dielectric layer and having an open end to feed the plurality of pairs of slots.

According to the present invention, it is possible to form a plurality of pairs of slots on a ground surface of a single dielectric layer to emit a field and form a micro-strip line with an open end on another surface of the single dielectric layer to feed the plurality of pairs of slots. Through this, it is possible to widely form a uniform near field.

Also, according to the present invention, it is possible to form a pair of slots in a position that is spaced apart from an end of a micro-strip line by λ/4, and where a current distribution is maximum based on a resonant frequency, and in a position that is spaced apart from the position of λ/4 by λ, and where the current distribution is maximum. Through this, it is possible to feed current distribution with a uniform magnitude and phase.

Also, according to the present invention, it is possible to adjust a field coupling amount excited in two slots using any one of a slot width, a slot length, an interval between two slots, and an offset length between the slots.

### BRIEF DESCRIPTION OF THE DRAWINGS

The above and other aspects of the present invention will become apparent and more readily appreciated from the following detailed description of certain exemplary embodiments of the invention, taken in conjunction with the accompanying drawings of which:

FIG. 1 is a side cross-sectional view illustrating a near-field radio frequency identification (RFID) reader antenna according to an embodiment of the present invention;

FIG. 2 is a side cross-sectional view illustrating a current distribution in the form of a standing wave on a micro-strip line of a near-field RFID reader antenna according to an embodiment of the present invention;

FIG. 3 illustrates an equivalent circuit diagram of a near-field RFID reader antenna according to an embodiment of the present invention;

FIG. 4 is a perspective view illustrating a near-field RFID reader antenna according to an embodiment of the present invention;

FIG. 5 is a top plane view illustrating a slot structure formed on a ground surface in a near-field RFID reader antenna according to an embodiment of the present invention;

FIG. 6 is a top plane view illustrating a micro-strip line feeding structure in a near-field RFID reader antenna according to an embodiment of the present invention; and

FIG. 7 is a perspective view illustrating an electric field distribution uniformly formed on a near-field RFID reader antenna according to an embodiment of the present invention.

### DETAILED DESCRIPTION OF EXEMPLARY EMBODIMENTS

Reference will now be made in detail to exemplary embodiments of the present invention, examples of which are illustrated in the accompanying drawings, wherein like reference numerals refer to the like elements throughout. The exemplary embodiments are described below in order to explain the present invention by referring to the figures.

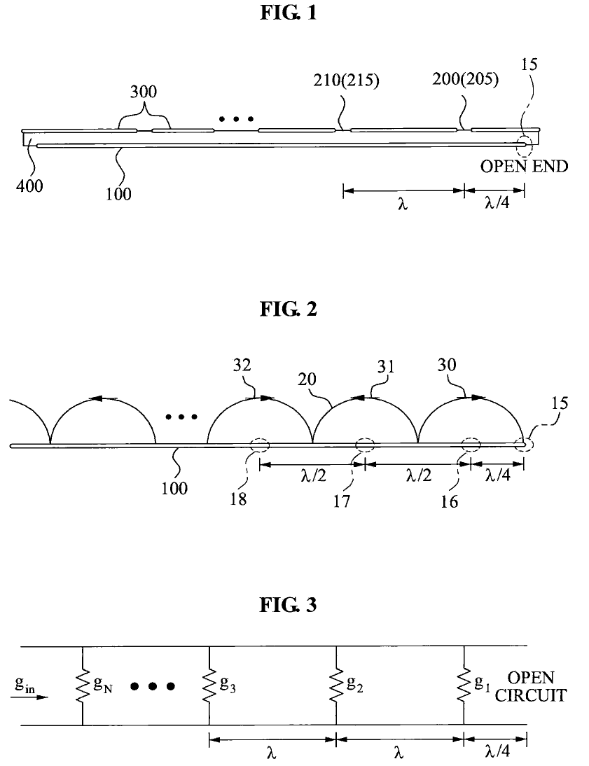

FIG. 1 is a side cross-sectional view illustrating a near-field radio frequency identification (RFID) reader antenna according to an embodiment of the present invention.

The near-field RFID reader antenna forms a plurality of pairs of slots 200 and 205, and 210 and 215 on a ground surface 300 of a single dielectric layer 400 or a single dielectric substrate to emit a field, and forms a micro-strip line 100 with an open end 15 on another surface of the single dielectric layer 400 to feed the plurality of pairs of slots 200 and 205, and 210 and 215.

As shown in FIG. 1, the ground surface 300 includes a first pair of slots 200 and 205 and a second pair of slots 210 and 215 in a particular shape that are periodically formed for emission of electromagnetic waves. The ground surface 300 is formed on the top surface of the single dielectric substrate 400. Also, the micro-strip line 100 with the open end 15 and current distribution in a standing wave form is formed on the bottom surface of the single dielectric substrate 400.

The first pair of slots 200 and 205 is formed in a position that is spaced apart from the open end 15 of the micro-strip line 100 by λ/4 and where the current distribution is maximum. The second pair of slots 210 and 215 is formed in a position that is spaced apart from the position of λ4 by λ.

λ may be in inverse proportion to a resonant frequency. According to an aspect, λ may change in proportion to an inverse number of a resonant frequency.

Hereinafter, descriptions will be made with reference to FIG. 2.

FIG. 2 is a side cross-sectional view illustrating a current distribution in the form of a standing wave on the micro-strip line 100 of a near-field RFID reader antenna according to an embodiment of the present invention.

As shown in FIG. 2, the end 15 of the micro-strip line 100 is open. Therefore, when feeding the slots 200, 205, 210, and 215, a traveling wave and reflected wave are mixed to thereby form the standing wave. Although the current distribution barely exists in the end 15, the current distribution may be maximum in a position 16 that is traveled from the end 15 by the distance of λ/4.

For each travel period from the position 16 where the current distribution is maximum by λ/2, another maximum current distributions, for example, positions 17 and 18, where the current distribution is maximum may periodically exist. However, a difference between a current phase 30 in the position 16 and a current phase 31 in the position 17 traveled from the position 16 by λ/2 may be about 180 degrees. Also, a difference between the current phase 31 in the position 17 and a current phase 32 in the position 18 traveled from the position 17 by λ/2 may be about 180 degrees.

Specifically, in the end 15 of the micro-strip line 100 and the position 18 traveled from the position 16 by λ, the current distribution is maximum and the current phases 30 and 32 are the same as each other.

Accordingly, by periodically forming the first pair of slots 200 and 205 in the position 16 with the maximum current distribution and the same phase and the second pair of slots 210 and 215 in the position 18 with the maximum current distribution and the same phase on the micro-strip line 100, it is possible to uniformly form the magnitude and phase of current that is fed to the first pair of slots 200 and 205 and the second pair of slots 210 and 215.

The plurality of pairs of slots 200 and 205, and 210 and 215 formed on the ground surface 300 may be formed in various shapes according to application of the present invention and a plurality of slots may be provided. When travel is made from the position where the first pair of slots 200 and 205 is formed by λ, a position with the same current distribution and phase as the location where the first pair of slots 200 and 205 is formed may exist. By forming the second pair of slots 210 and 215 the same as the first pair of slots 200 and 205 in the traveled position, two pairs of slots 200 and 205, and 210 and 215 may be fed with the same current distribution and phase.

Specifically, by forming the second pair of slots 210 and 215 on the ground surface 300 of the micro-strip line 100 by each period of λ based on the first pair of slots 200 and 205 formed on the micro-strip line 100 where the current distribution exists in the standing wave form, it is possible to emit a field with the same magnitude and phase in a plurality of emitting slots.

According to an aspect, the near-field RFID reader antenna may emit the field by adjusting a field coupling amount according to at least one of a slot width, a slot length, an interval between slots constituting a pair, for example, the slots 200 and 205, and an offset length between the slots 200 and 205.

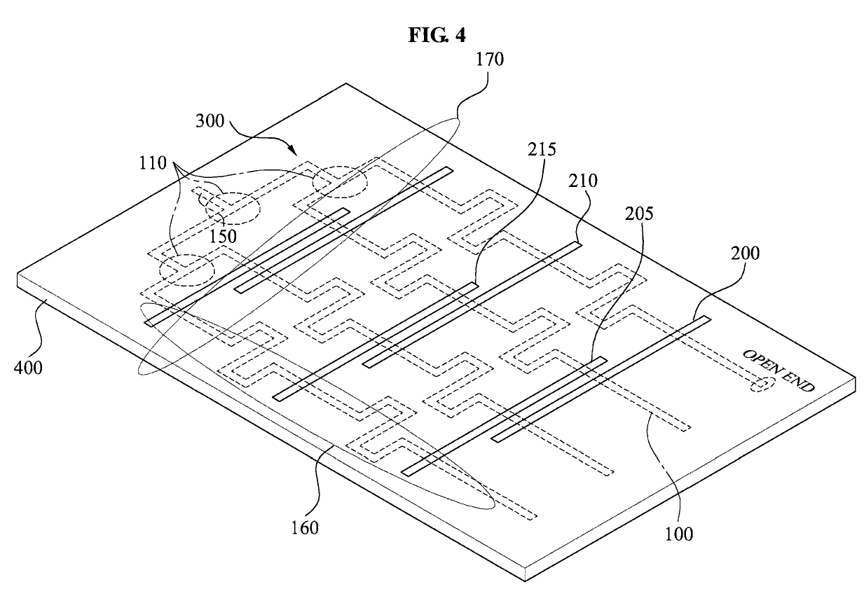

FIG. 3 illustrates an equivalent circuit diagram of a near-field RFID reader antenna according to an embodiment of the present invention.

As shown in FIG. 3, when the first pair of slots 200 and 205, and the second pair of slots 210 and 215 resonate in the actual design frequency, the near-field RFID reader antenna may equalize an antenna using the simple circuit.

Input conductance gin of the near-field RFID reader antenna may be calculated according to,

$${g}_{in} = {\sum }_{n = 1}^{N} {g}_{n} . \qquad [ Equation 1 ]$$

The input conductance gin may be calculated according to a total sum of g1, g2, g3 . . . gn.

When it is assumed that the micro-strip line 100 does not have loss, it is possible to equalize the field emitted from the first pair of slots 200 and 205, and the second pair of slots 210 and 215 to g1, g2, g3 . . . Specifically, a field amount emitted from the first pair of slots 200 and 205 may be equalized to g1, and a field amount emitted from the second pair of slots 210 and 215 may be equalized to g2. In a general series feeding scheme, g1, g2, g3 . . . may sequentially increase. According to an aspect of the present invention, g1, g2, g3 . . . may be designed to be the same by changing the slot width, the slot length, the interval between the slots 200 and 205, and the offset length between the slots 200 and 205.

FIG. 4 is a perspective view illustrating a near-field RFID reader antenna according to an embodiment of the present invention.

The near-field RFID reader antenna is targeted to obtain a uniform field distribution in a near-field zone, without a fading zone. For this, the near-field RFID reader antenna has a series feeding structure, or a series and parallel feeding structure. This is because the field distribution excited on a slot may not be uniform when a slot length formed on the ground surface 300 is long and in this instance, the single micro-strip line 100 is fed. Specifically, a relatively strong field may be excited in a location of the slot 200 crossing the micro-strip line 100, and a relatively weak field may be excited in a slot portion.

To overcome the above problem, the near-field RFID reader antenna may divide the power supplied to a feeding port 150 into four different power with the same magnitude using three power dividers 110 and then parallel feed the divided power supplies with respect to the micro-strip line 170. The supplied power may be series fed to a plurality of slots via a single micro-strip line 160. Through this, the near-field RFID reader antenna may readily adjust a field amount that is excited in the first pair of slots 200 and 205, and the second pair of slots 210 and 215.

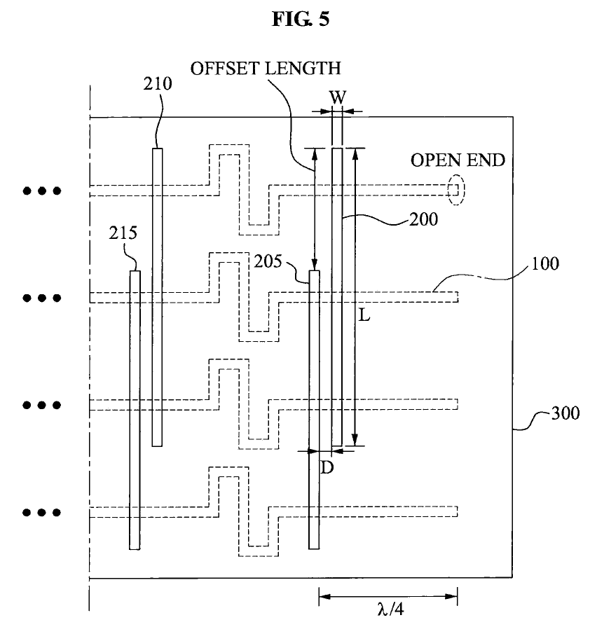

FIG. 5 is a top plane view illustrating a slot structure formed on a ground surface in a near-field RFID reader antenna according to an embodiment of the present invention.

As shown in FIG. 5, the near-field RFID reader antenna may form a first pair of slots 200 and 205, and a second pair of slots 210 and 215 and adjust a resonant frequency using a slot length “L”. Also, the near-field RFID reader antenna may control a field amount excited in the first pair of slots 200 and 205, and the second pair of slots 210 and 215 using a slot width “W”, an interval “D” between two slots constituting a pair, for example, the slots 200 and 205, or 210 and 215, and an offset length between the slots.

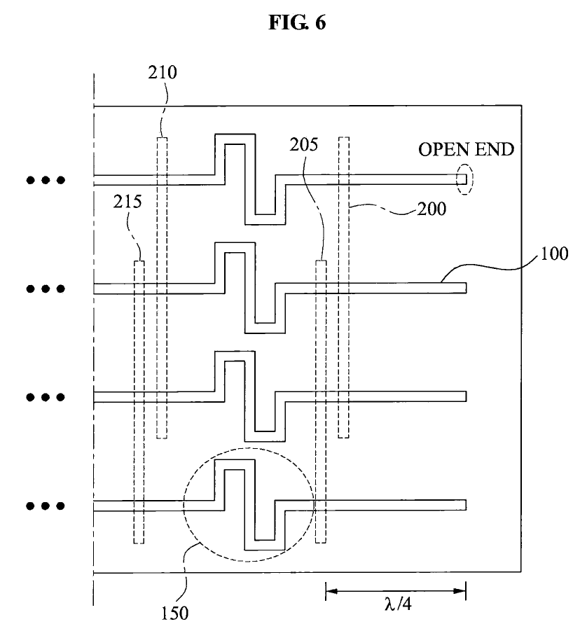

FIG. 6 is a top plane view illustrating a micro-strip line feeding structure in a near-field RFID reader antenna according to an embodiment of the present invention.

In order to feed a uniform field with the sample phase in a plurality of slots that is periodically formed on a ground surface 300, a micro-strip line 100 includes four lines and is in the structure of a meander line 105. The meander line 105 may be in various types of structures as required in order to excite the field with the same phase in the plurality of slots. Also, an end of the micro-strip line 100 is open and may form a first pair of slots 200 and 205 in a position that is spaced apart from the end by λ/4 and a second pair of slots 210 and 215 in a position that is spaced apart from the position of λ/4 by λ.

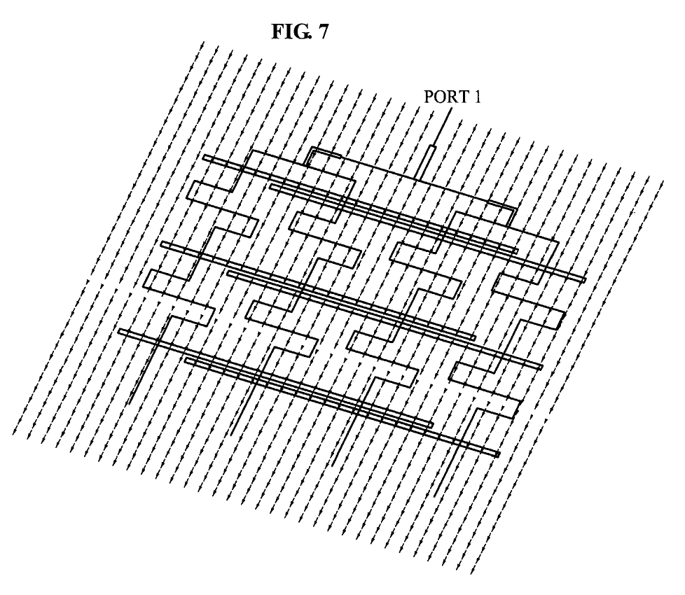

FIG. 7 is a perspective view illustrating an electric field distribution uniformly formed on a near-field RFID reader antenna according to an embodiment of the present invention.

As shown in FIG. 7, the electric field distribution may be uniformly distributed in the same direction in a near-field zone of the near-field RFID reader antenna. Specifically, there is no fading zone where the field distribution does not exist and the electric field distribution is uniformly formed in the same direction.

In the item-level tagging RFID application, the near-field RFID reader antenna may have a wide near-field zone of recognition region using a single-layer antenna. Specifically, according to an aspect of the present invention, it is possible to support the wide region using a simple structure by series feeding slots periodically formed on a ground surface using a single micro-strip line. The antenna structure constructed as above may be usefully adopted for item-level tagging RFID applications, for example, a bookcase for book management, a smart shelf for display of products in a department store, and the like.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A near-field radio frequency identification (RFID) reader antenna comprising:
a plurality of pairs of slots being formed on a ground surface of a single dielectric layer to emit a field; and
a micro-strip line being formed on another surface of the single dielectric layer and having an open end to feed the plurality of pairs of slots.

2. The near-field RFID reader antenna of claim 1, wherein the plurality of pairs of slots is periodically formed in a position where a current distribution is maximum, based on a resonant frequency.

3. The near-field RFID reader antenna of claim 1, wherein the plurality of pairs of slots is formed in a position that is spaced apart from the open end of the micro-strip line by λ/4 or in a position that is spaced apart by λ from the position that is spaced apart from the open end of the micro-strip line by λ/4.

4. The near-field RFID reader antenna of claim 1, wherein each slot emits the field according to a field coupling amount and the field coupling amount is adjusted according to at least one of a slot width, a slot length, an interval between slots constituting a pair, and an offset length between the slots.

5. The near-field RFID reader antenna of claim 1, wherein the micro-strip line is in the structure of a meander line.

6. The near-field RFID reader antenna of claim 1, wherein the micro-strip line feeds the plurality of pairs of slots using any one of a series scheme, a parallel scheme, and a series and parallel scheme.
